(19) United States
(12) Patent Application Publication
(10) Pub. No.: US 2014/0298892 A1
(43) Pub. Date: Oct. 9, 2014

(54) AIR PERMEABILITY APPARATUS

(71) Applicant: Nils Fretz, Uetikon a. See (CH)

(72) Inventor: Nils Fretz, Uetikon a. See (CH)

(73) Assignee: TEXTEST AG, Schwerzenbach (CH)

(21) Appl. No.: 14/130,856

(22) PCT Filed: Jul. 8, 2011
(86) PCT No.: PCT/EP2011/061659

§ 371 Date: Mar. 5, 2014

(51) Int. Cl. G01N 15/08

(52) U.S. Cl. CPC G01N 15/08
USPC 73/38

(57) ABSTRACT

An air permeability apparatus has a test head with an opening, a vacuum pump, a clamping arm and an orifice disk that is rotatable around its central axis. The orifice disk is arranged between tubes and the vacuum pump and has a plurality of orifices. The orifice disk has at least one slit, the slit extending from an area of the perimeter of the orifice disk towards a central opening of the orifice disk. The length of the slit overlaps a contact area between a first ending of one of the tubes and the surface of the orifice when the slit is in a cleaning position and/or an air jet nozzle is aimed towards the orifice disk.

The present invention relates to an air permeability apparatus and to a method of for measuring air permeability with an air permeability apparatus.

Air permeability apparatus are utilized to determine air permeability of all kinds of flat materials and of foam cubes. The measuring range covers dense papers and airbag fabrics as well as non-wovens.

Substantially, known air permeability apparatus comprise a test head with an opening, a vacuum pump for drawing air through the opening of the test head and a clamping arm. The air flow through the test specimen is determined with an orifice disk having orifices of different sizes. The air permeability of the test specimen is determined from the pressure drop across the orifice of the orifices, where said pressure drop occurs.

One object of the present invention is to provide an improved air permeability apparatus.

The object is solved by the features given in claim 1. Further embodiments of the present invention are given in dependant claims.

An air permeability apparatus is suggested comprising a test head with an opening, a vacuum pump, a clamping arm and an orifice disk being rotatable around its central axis, wherein the orifice disk is arranged between tubes and the vacuum pump, and wherein the orifice disk has a plurality of orifices. Furthermore, the orifice disk comprises at least one slit, the slit extending from an area of the perimeter of the orifice disk towards a central opening of the orifice disk. Furthermore, the length of the slit overlaps a contact area between a first ending of one of the tubes and the surface of the orifice when the slit is in a cleaning position and/or an air jet nozzle being aimed towards the orifice disk. Thereby, dust deposit in the orifices of the orifice disk is prevented to a great extent. Thus, an accurate test result can be obtained since falsification of the test result is prevented and since unwanted pressure drop is averted.

In another embodiment, the orifices have a diameter in a range between 0.2 mm to 30 mm.

In another embodiment the orifice disk is made out of a material as metal, ceramics, resin, plastics, wherein the material is coated or uncoated.

In another embodiment, the clamping arm comprises a mounting structure, wherein a back part of the mounting structure is formed wider than the opening of the test head, preferably the mounting structure is bifurcated-like, wherein the mounting structure is pivotable attached to a socket. Thereby, a misalignment of the test head is prevented.

In another embodiment, the test head comprises a rapid connection, preferably a snap-on mounting, for connecting or disconnecting the test head to the clamping arm. Thereby, the test head is easily interchangeable.

In a further embodiment, the test head comprises a top part and a bottom part, which are connectable to each other by pressing the clamping arm downwards. Thereby, misalignment between the top part and the bottom part of the test head is prevented.

In another embodiment, the clamping arm comprises an analysis unit, preferably being designated to save and store series of data by using integrated software.

In another embodiment, another vacuum pump is connected to a closed casing, wherein the closed casing is provided in an area of the opening of the test head. Thereby, air leakage in a boundary area of the test specimen to be measured is prevented.

Another aspect on the invention relates to a method for measuring air permeability with an air permeability apparatus comprising a test head with an opening, a vacuum pump, a clamping arm and an orifice disk rotabtable around its central axis, wherein the orifice disk (8; 8′) is arranged between tubes and the vacuum pump. The orifice disk comprises:
at least one slit, the slit extending from an area of the perimeter of the orifice disk towards a central opening of the orifice disk and that the length of the slit overlaps a contact area between a first ending of one of the tubes and the surface of the orifice when the slit is in a cleaning position; and/
or an air jet nozzle being aimed towards the orifice disk, comprising the steps of:
before establishing a predetermined test pressure, a first cleaning step is performed in blowing air through the orifices of the orifice disk;
performing a second cleaning step in aspirating dust deposit of a tube via a slit of the orifice disk by activating the vacuum pump.

Thereby, possible dust deposit in the orifices or dust deposit in the tube can easily be removed without disassembling the apparatus, respectively. Thus, downtime of the apparatus is minimized. Furthermore, an accurate test result can be obtained since falsification of the test result is prevented.

The present invention is further explained with the aid of examples of embodiments, which are shown in figures. There is shown:

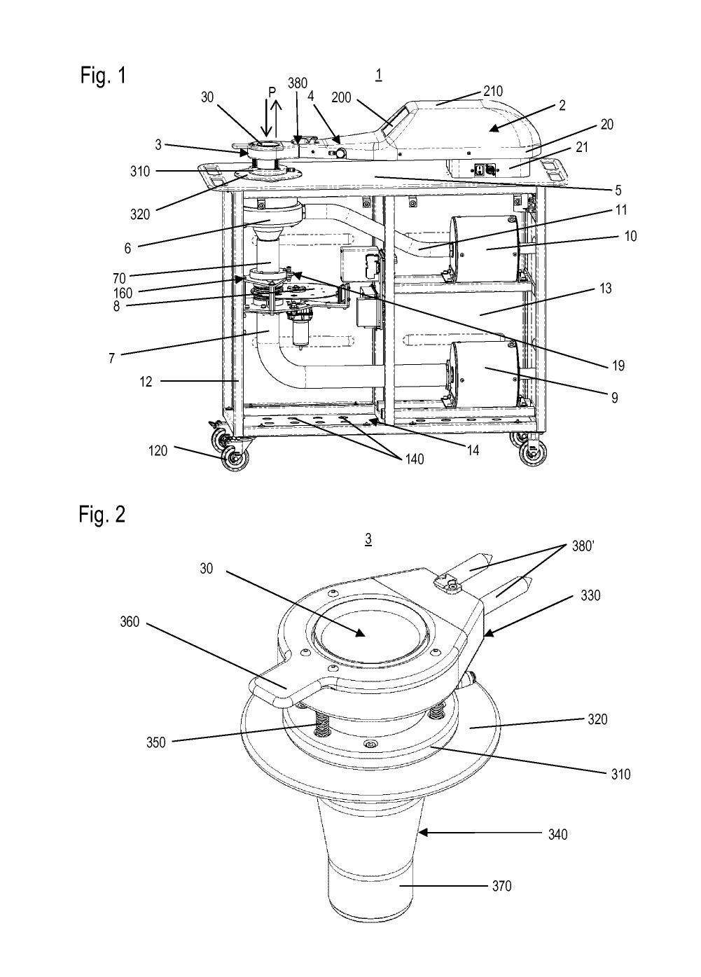

FIG. 1 schematically, an air permeability apparatus;

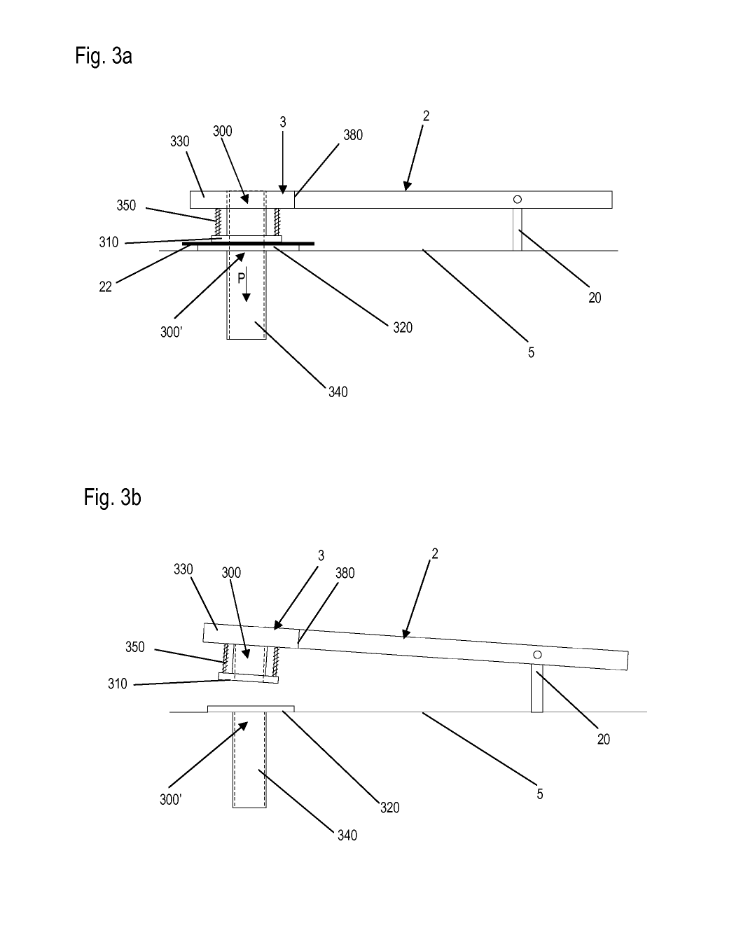

FIG. 2 schematically, a test head of an air permeability apparatus;

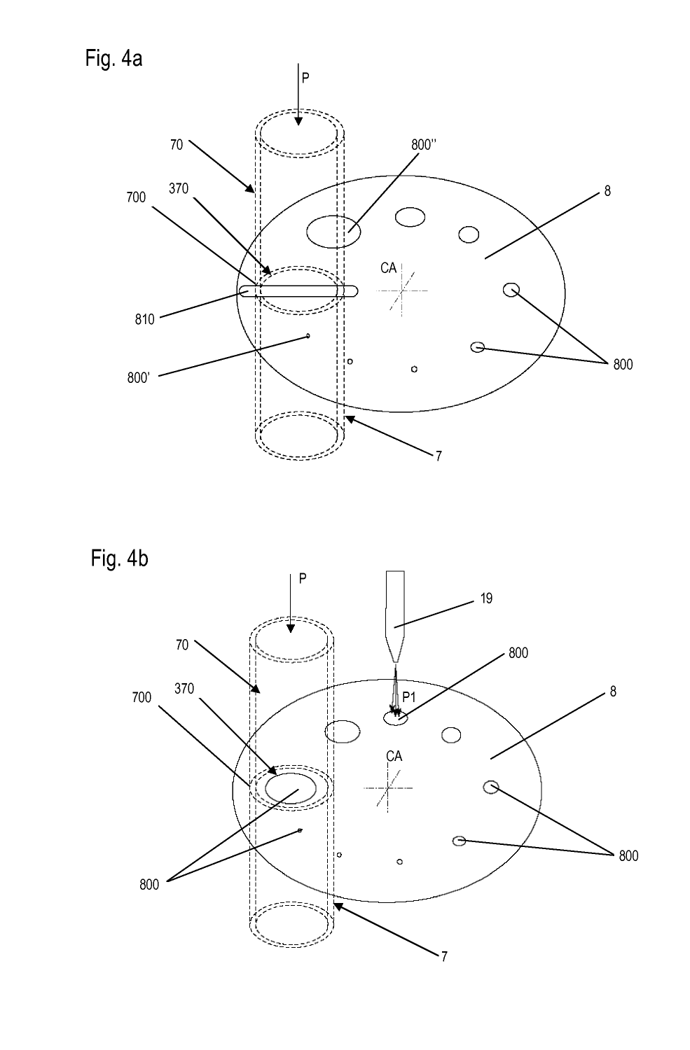

FIG. 3a schematically, a clamping arm pressed down against a test specimen;

FIG. 3b schematically, a clamping arm positioned in upward direction;

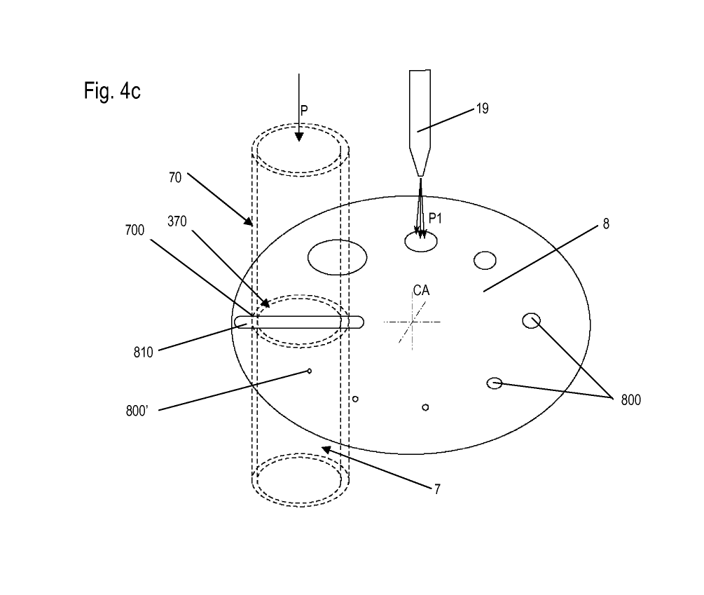

FIG. 4a a horizontally arranged orifice disk with a slit;

FIG. 4b a horizontally arranged orifice disk with an air jet nozzle aimed at the orifice disk;

FIG. 4c a horizontally arranged orifice disk with a slit and an air jet nozzle.

In FIG. 1, schematically, an air permeability apparatus 1 is depicted. The air permeability apparatus 1 comprises an analysis unit 2 being operationally connected to a test head 3 having an opening 30. The analysis unit 2 comprises a screen 200 and a printer 210. The analysis unit 2 is designated to save and store series of data by using integrated software. A clamping arm 4 is arranged between the analysis unit 2 and the test head 3. A detachable rapid connection 380 between the clamping arm 4 and the test head 3 allows detachment of the test head 3 easily, for example when the test head 3 has to be changed. The rapid connection 380 can be a snap-on mounting for example. The clamping arm 4 as depicted in FIG. 1 is pressed down such that a pressing plate 310 of the test head 3 contacts a work plate 5. The test head 3 is mounted in interchangeable manner. The appropriate test head 3 having an opening of a defined size for the test standard selected is mounted onto the clamping arm 4 to measure air permeability of a test specimen to be measured. The opening 30 runs throughout a top part of the test head 3 to a bottom part of the test head 3 carrying the pressing plate 310. A test specimen (not shown in FIG. 1) is arranged between the pressing plate 310 and a contact plate 320 of the bottom part of the test head 3 such that the opening 30 is covered by the test specimen. The test specimen can be of all kinds of flat materials or of foam cubes. The measuring range covers test specimens like dense papers and airbag fabrics as well as extremely open non-wovens and forming fabrics for example. After a test cycle is finished, the clamping arm 3 can be moved upward. The clamping arm 3 is pressed down again when starting another test cycle (see arrows depicted in FIG. 1). A closed casing 6 is arranged underneath the work plate 5 being connected to a tube 7. Furthermore, an orifice disk 8 is arranged between the test head 3 and a vacuum pump 9. The orifice disk 8 is mounted with the aid of a mounting structure 160, like a carrier for example. The flat orifice disk 8 is rotatably arranged around its central axis. The orifice disk 8 is arranged between a first tube 70 and a second tube 7. Both tubes 70, 7 are operationally connected to the test head 3 and to the vacuum pump. The vacuum pump 9 is activated automatically as soon as the clamping arm 4 is pressed down against the work table 5. A pre-selected test pressure is automatically maintained, and after a few seconds a test result of an air permeability of the test specimen is displayed at the screen 200. By pressing down the clamping arm 4 a second time the test specimen is released and the vacuum pump 9 is shut-off. The orifice disk 8 is arranged in parallel manner with respect to the opening 30 of the test head 3. Furthermore, the orifice disk 8 is arranged paralelly spaced with respect to the opening 300 of the test head 3. Another vacuum pump 10 is connected via another tube 11 to the casing 6. The other vacuum pump 10 is optionally mountable. If necessary, the other vacuum pump 10 can be used in order to prevent an air leakage in a boundary area between the test specimen to be measured. Furthermore, a mounting frame 12 provided with side walls 13 and a bottom plate 14 with holes 140 is depicted in FIG. 1. The frame 12 is provided with wheels 120. The clamping arm 4 is mounted onto the table 5 with the aid of a mounting structure 20. The mounting structure 20 is pivotable attached to a socket 21 to allow a swivelling movement in upward or downward direction. A front of the mounting structure 20 is formed narrower than a back part of the mounting structure 20. The shape of the mounting structure 20 is bifurcated-like. Furthermore, the back part of the mounting structure 20 is formed wider than the opening of the test head 3 being covered by the pressing plate 310. Thereby, misalignment of the test head 3 is prevented, even when the clamping arm 4 is pressed down unwarily by a user operating the air permeability test apparatus.

In FIG. 2, schematically, an interchangeable test head 3 of an air permeability apparatus 1 is depicted. The opening 30 of the test head 3 is running from the top part 330 of the test head 3 to the bottom part 340 of the test head 3 as a central hole. The pressing plate 310 is arranged at the top part 330 of the test head 3. The pressing plate 310 being a ring with a central recess protrudes from the test head 3. Furthermore, the pressing plate 310 is stabilized by resilient elements 350, e.g. as springs, being mounted in the top part 330. The top part 330 is mounted to the clamping arm 4 (not shown in FIG. 4) in up and down movable manner with respect to the bottom part 340. The top part 330 has another handle 360 arranged opposite to a rapid connector of a rapid connetction 380 (see FIG. 1), e.g. like two pins 380′ of a snap-on mounting designated to be rapidly connected or disconnected against a corresponding receiving part of the clamping arm 4. As explained in FIG. 1, the pressing plate 310 is designated to be clamped against a test specimen (not shown in figure 4). Furthermore, a connecting part 370 of bottom part 340 of the test head 3 is designated to be received by the first tube 70 (see FIG. 1) in order to provide an airtight connection, is depicted in FIG. 4. The connecting part 370 of the bottom part 340 is located underneath the work table 5 respectively underneath the pressing plate 310. Both parts, i.e. the top part 330 and the bottom part 340 of test head 3 are interchangeable, thus different types of test heads each having a different diameter of its circular opening can be selected. The diameter of the different test heads 3 are in a range from 1 cm² to 120 cm², preferably in a range of 5 cm² to 100 cm². By pressing the top part 320 of the test head 3 against the work plate 5 as depicted in FIG. 1, the vacuum pump 9 is automatically activated.

In FIG. 3a, schematically, the clamping arm 2 is pressed down effecting clamping of the test specimen 22 between the top part 330 and the bottom plate 320 of the bottom part 340 of the test head 3. Thus, the opening 300 of the top part 330 of the test head 3 is aligned to another opening 300′ of the bottom part 340 of the test head 3. The openings 300, 300′ together form the opening 30 of the test head 3. The pressing plate 310 of the top part 330 is stabilized with the aid of stabilizing elements 340, like e.g. springs. The bottom part 340 is mounted in removable manner into the work table 5. Furthermore, the mounting structure 20 of the clamping arm 4 is depicted. The air flow caused by the activated vacuum pump 9 draws air trough the test specimen 22 indicated by arrows P in FIG. 3a.

In FIG. 3b, schematically, the clamping arm 4 is positioned in upward direction, i.e. the pressing plate 310 of the top part 330 of the test head 3 is not pressed down anymore against the bottom plate 320 of the bottom part 340 of the test head 3. This position allows changing of both parts of the test head 3, i.e. changing of the top part 330 and changing of the bottom part 340. In this position, the test specimen (not shown in FIG. 3b) can be brought into the designated measuring position.

In FIG. 4a, the orifice disk 8 is depicted. The circular orifices 800 are arranged the centrals axis CA of the orifice disk 8. The orifices 800 are of different sizes, in a range between 0.2 mm to 30 mm, preferably in a range of 0.5 mm to 27 mm, arranged in sequence from the smallest orifice 800′ to the biggest orifice 800″. It is also conceivable to arrange the different sizes of the orifices 800 in different manner in the orifice disk 8. The slit 810 is a cleaning slit in order to eliminate dust deposit originating from the tube 70 respectively originating from the casing 6 according to FIG. 1. The slit 810 is arranged in radial manner with respect to the central opening 820 between the smallest and the biggest orifice 800′, 800″. The slit 810 extends from an area of the perimeter of the disk-like orifice disk 8 towards the central opening 820. A first ending 700 of the first tube 70 is put over the slit 810 in such way that the length of the slit 810 a contact area 370 between the first ending 700 of the tube 70 and a surface of the orifice disk 8. It is also conceivable that a flange of a pressing element (not shown in FIG. 3b) is pressed down against the orifice disk 8. The pressing element is movable in upward and downward direction. In the position depicted in FIG. 3a, the orifice disk 8 is in a cleaning position. The orifice disk 8 can be made out of metal, ceramics, resin, plastics for example. The material can be coated or uncoated. Dust deposit deposited onto the orifice disk 8, possibly caused due rotation of the orifice disk 8 into different measuring positions, can be removed when the first ending 700 of the tube 70 is positioned such that the contact area 370 between the first ending 700 of the tube 70 and one of the surfaces of the orifice disk 8 is smaller than the length of the slit 810. The contact area 370 between the tube 70 and the orifice disk 8 can be an edge of the tube 70 contacting the surface of the orifice disk 8. Or the contact area 370 between the tube 70 and the orifice disk 8 can be the edge of the tube 70 carrying sealing parts contacting the surface of the orifice disk 8. Or the contact area 370 between the tube 70 and the orifice disk 8 can be the sealing parts protruding from the first end 700 of the tube 70 contacting the surface of the orifice disk 8. The slit 810 is arranged in radial manner between the smallest 800′ and the biggest 800″ of the orifices 800.

In FIG. 4b, schematically, the orifice disk 8 with the orifices 800 and an air jet nozzle 19 aimed towards the orifice disk 8 is depicted. With the aid of the air jet nozzle 19 dust deposit within the orifices 800 of the orifice disk 8 can be removed. The orifice disk 8 and the air jet nozzle 19 aimed torwards the orifice disk 8 can be mounted in the air permeability apparatus 1 according to FIG. 1.

In FIG. 4c, schematically, the orifice disk 8 having the slit 810 according to FIG. 4a and an air jet nozzle 19 according to FIG. 4b is depicted. The orifice disk 8 as depicted in FIG. 4c can be mounted in the other air permeability apparatus 1 according to FIG. 1. The air jet nozzle 19 is arranged such that that the air jet nozzle 19 is aimed at the orifice disk 8. A method for measuring air permeability with the aid of the air permeability apparatus 1 comprises a first cleaning step to clean the orifices, before measuring is started in establishing a determined test pressure. Pressurized air, for example, can be used to blow air trough the orifices 800. In a second, subsequent cleaning step, a dust deposit, originating e.g. from a previous measurement cycle, within the first tube 70 is removed via the slit 810 in activating the vacuum pump 9. In this cleaning position, the slit 810 is arranged ahead an aperture of the first ending 700 of the tube 70. The slit 810 extends from the perimeter or it is also conceivable that the slit extends from an area of the perimeter of the disk-like orifice disk 8 towards the central opening 820 and that the length of the slit overlaps the opening 300 of the test head 3 when the slit 810 is positioned in said cleaning position. The aperture of the first ending 700 of the tube 70 is directed to the orifice disk 8. It is also conceivable that the flange of the pressing element (not shown in FIG. 3c) is pressed down against the orifice disk 8. After blowing air through the orifices 800, the dust deposit resulting from the measuring operation and the dust deposit blown into the second tube 7 due to the first cleaning step are removed from the second tube 7 in activating the vacuum pump 7. A second ending 710 of the tube 7 is connected to the closed casing 6 (see FIG. 1). The closed casing 6 is also connected to the work plate 5, wherein the closed casing 6 is arranged in concentric manner with respect to an aperture of the work plate 5. When the air has passed trough the test specimen 22, wherein the quantity of the air passed trough the test specimen 22 depends on the test conditions and the properties of the test specimen 22, this quantity of air further passes through the orifice 800 of the orifice disk 8. The air flow through the test specimen is measured by the aid of the orifices 800, whereby each of the orifices 800 is individually selectable in rotating the orifice disk 8 around its central axis CA. Thereby, the air flow through the test specimen can be measured by adjusting a diameter of the orifices 800 in rotating in selectable manner the orifice disk 8 relative to the tube 70, the tube 70 being arranged in fix manner. The measured result of the air flow allows to determine pressure drop at a given air velocity. The air permeability of the test specimen is determined from the pressure drop across this specific orifice. Furthermore, the air jet nozzle 19 (see FIG. 1) can be mounted onto the mounting structure 160. The air jet nozzle 19 serves to clean respectively to blow air through each of the orifices 800 in order to eliminate or to prevent clogging of the orifices 800.

1. An air permeability apparatus (1) comprising a test head (3) with an opening (300), a vacuum pump (9), a clamping arm (4) and an orifice disk (8; 8′) being rotatable around its central axis (CA), wherein the orifice disk (8; 8′) is arranged between tubes (70; 7) and the vacuum pump (9), and wherein the orifice disk (8; 8′) has a plurality of orifices (800; 800′; 800″), characterized in that the orifice disk (8) comprises:
at least one slit (810), the slit (810) extending from an area of the perimeter of the orifice disk (8) towards a central opening (820) of the orifice disk (8) and that the length of the slit (810) overlaps a contact area (370) between a first ending (700) of one (70) of the tubes (70; 7) and the surface of the orifice (8) when the slit (810) is in a cleaning position; and/
or an air jet nozzle (19) being aimed towards the orifice disk (8; 8′).

2. An air permeability apparatus (1) according to claim 1, characterized in that the orifices (800; 800′; 800″) have a diameter in a range between 0.2 mm to 30 mm.

3. An air permeability apparatus (1) according to claim 1, characterized in that the orifice disk (8; 8′) is made out of a material as metal, ceramics, resin, plastics, wherein the material is coated or uncoated.

4. An air permeability apparatus (1) according to claim 1, characterized in that the clamping arm (4) comprises a mounting structure (20), wherein a back part of the mounting structure (20) is formed wider than the opening (300) of the test head (3), preferably the mounting structure (20) is bifurcated-like, wherein the mounting structure (20) is pivotable attached to a socket (21).

5. An air permeability apparatus (1) according to claim 1, characterized in that the test head (3) comprises a rapid connection (360), preferably a snap-on mounting, for connecting or disconnecting the test head (3) to the clamping arm (4).

6. An air permeability apparatus (1) according to claim 1, characterized in that the test head (3) comprises a top part (320) and a bottom part (330), which are connectable to each other by pressing the clamping arm (4) downwards.

7. An air permeability apparatus (1) according to claim 1, characterized in that the clamping arm (4) comprises an analysis unit (2), preferably being designated to save and store series of data by using integrated software.

8. An air permeability apparatus (1) according to claim 1, characterized in that another vacuum pump (10) is connected to a closed casing (6), wherein the closed casing (6) is provided in an area of the opening (300) of the test head (3).

9. Method for measuring air permeability with an air permeability apparatus (1) comprising a test head (3) with an opening (300), a vacuum pump (9), a clamping arm (4) and an orifice disk (8; 8′) being rotabtable around its central axis (CA), wherein the orifice disk (8; 8′) is arranged between a tube (7) and the vacuum pump (9), wherein the orifice disk (8) comprises at least one slit (810), the slit (810) extending from an area of the perimeter of the orifice disk (8) towards a central opening (820) of the orifice disk (8) and that the length of the slit (810) overlaps a contact area between a first ending (700) of a tube (7) and the surface of the orifice (8) when the slit (810) is in a cleaning position and/or an air jet nozzle (19) being aimed towards the orifice disk (8; 8′) comprising the steps of:
before establishing a predetermined test pressure, a first cleaning step is performed in blowing air through the orifices (800; 800′; 800″) of the orifice disk (8; 8′);
performing a second cleaning step in aspirating dust deposit of a tube (7) via a slit (810) of the orifice disk (8; 8′) by activating the vacuum pump (9).
